(19) United States
(12) Patent Application Publication
(10) Pub. No.: US 2004/0180262 A1
(43) Pub. Date: Sep. 16, 2004

(54) Battery case having a flange in the terminal hole

(76) Inventor: Dahluen Huang, Chungho City (TW)

Correspondence Address: BRUCE H. TROXELL, SUITE 1404, 5205 LEESBURG PIKE, FALLS CHURCH, VA, 22041, US

(21) Appl. No.: 10/729,948

(22) Filed: Dec. 9, 2003

(30) Foreign Application Priority Data
Mar. 11, 2003 (TW) 092203695

(51) Int. Cl. H01M 2/30

(52) U.S. Cl. 429/181; 429/178

(57) ABSTRACT

A battery case having a terminal hole in the peripheral wall, a circular flange protruded from the inside wall around the terminal hole, and a contact member mounted in the terminal hole for the contact of the positive terminal of a battery, the contact member having a cylindrical mounting portion riveted to the terminal hole, a contact portion supported on the circular flange for the contact of the positive terminal of the battery, and a connecting portion extended from the contact portion and closely attached to the sloping periphery of the circular flange and connected to the corresponding electric wire.

### BACKGROUND OF THE INVENTION

1. Field of the Invention

The present invention relates to a battery case and, more particularly, to such a battery case, which has an inside flange protruded from the inside wall around the terminal hole to support the contact portion of the contact member in positive contact with the positive terminal of the battery and to prohibit direct contact between the electric wire connecting portion of the contact member and the battery.

2. Description of the Related Art

The development of battery has a long history. Storing electricity in cylindrical energy storage means for necessary use brings a great convenience to human life. The application of dry batteries breaks through the limitations of use of electric appliances.

Various container means (battery cases) have been disclosed for holding a battery. FIG. 1 shows a battery case 10 according to the prior art. The battery case 10 has a terminal hole 102 in the peripheral wall 101 corresponding to the positive terminal of the battery, and a metal contact member 20 mounted in the terminal hole 102. The metal contact member 20 has a tubular body portion 201 mounted in the terminal hole 102, a contact portion 202 closely attached to the inner surface of the peripheral wall 101 for the contact of the positive terminal of the battery, and a protruding connecting portion 203 extended from the contact portion 202 and electrically connected to the corresponding electric wire 204 by clamping or soldering. This design of battery case 10 is still not satisfactory in function because the connecting portion 203 may touch the shell (negative pole) of the battery during installation of the battery in the battery case 10.

FIG. 2 shows another design of battery case 30. According to this design, the battery case 30 comprises a terminal hole 302 in the peripheral wall 301 corresponding to the positive terminal of the battery, a recess 303 at the outer surface of the peripheral wall 301 around the terminal hole 302, a conducting plate 40 mounted in the recess 303, a washer 50 mounted in the recess 303 and supported on the conducting plate 40, and a contact member 60 riveted to the terminal hole 302 to secure the conducting plate 40 and the washer 50 to the battery case 30. The contact member 60 has a round contact head 601 disposed inside the battery case 30 for the contact of the positive terminal of the battery. The conducting member 40 has a protruding connecting portion 401 connected to the corresponding electric wire 402. The connection area between the connecting portion 401 and the electric wire 402 is sealed with an electrically insulative jacket 403. This design of battery case still has drawbacks. Because the contact member 60 is a solid member, it is not easy to hold the contact member 60 in position with an implement during installation. Therefore, the installation of the contact member 60 cannot be achieved by a fully automatic machine. Further, because the connecting portion 401 is extended to the outside of the battery case 30, it tends to be broken accidentally. The use of the electrically insulative jacket 403 also greatly complicates the fabrication of the battery case 30.

Therefore, it is desirable to provide a battery case that eliminates the aforesaid drawbacks.

### SUMMARY OF THE INVENTION

The present invention has been accomplished under the circumstances in view. It is the main object of the present invention to provide a battery case, which prevents accidental contact of the positive contact member with the shell of the battery. To achieve this and other objects of the present invention, the battery case comprises a terminal hole in a peripheral wall thereof, and a contact member mounted in the terminal hole for the contact of the positive terminal of a battery, the contact member having a cylindrical mounting portion riveted to the terminal hole and a contact portion disposed inside the battery case for the contact of the positive terminal of a battery, and a connecting portion extended from the contact portion and connected to an electric wire, wherein the peripheral wall of the battery case has a flange protruded from an inner surface thereof around the terminal hole and adapted to support the contact portion of the contact member and to keep the connecting portion of the contact member away from the battery to be positioned in the battery case.

### BRIEF DESCRIPTION OF THE DRAWINGS

FIG. 1 is a schematic drawing showing the arrangement of a positive contact member in a battery case according to the prior art.

FIG. 2 is a schematic drawing showing the arrangement of another design of positive contact member in a battery case according to the prior art.

FIG. 3 is a schematic drawing showing the arrangement of a positive contact member in a battery case according to the present invention.

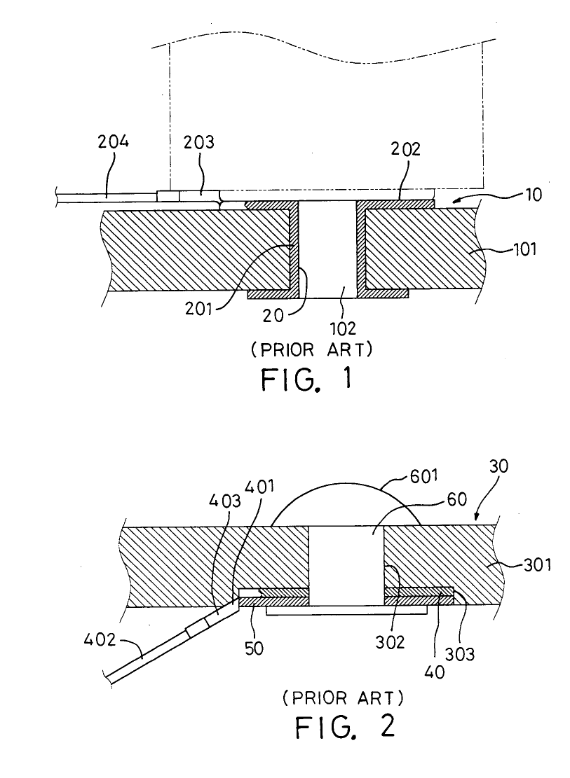

### DETAILED DESCRIPTION OF THE PREFERRED EMBODIMENT

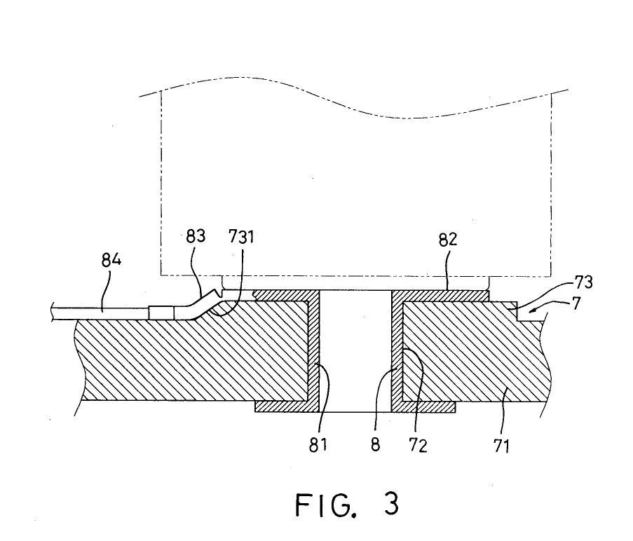

Referring to FIG. 3, a battery case 7 is shown having a peripheral wall 71, a terminal hole 72 in the peripheral wall 71, and a contact member 8 mounted in the terminal hole 72 for the contact of the positive terminal of the battery. The contact member 8 has a hollow cylindrical mounting portion 81 affixed to the periphery of the terminal hole 72, and a contact portion 82 closely attached to the inner surface of the peripheral wall 71 of the battery case 7 for the contact of the positive terminal of the battery. The battery case 7 further has a flange 73 protruded from the inner surface of the peripheral wall 71 around the terminal hole 72. According to this embodiment, the flange 73 has a circular shape. The size of the circular flange 73 is equal to or smaller than the contact portion 82 of the contact member 8. The contact member 8 further has a connecting portion 83 extended from the periphery of the contact portion 82 and connected to the corresponding electric wire 84. Further, the thickness of the flange 73 is greater than the diameter of the electric wire 84.

Referring to FIG. 3 again, the hollow cylindrical portion 81 of the contact member 8 is inserted into the terminal hole 72 to force the contact portion 82 into close contact with the flange 73, and then the hollow cylindrical mounting portion 81 of the contact member 8 is riveted to the terminal hole 72 of the battery case 7. When riveting the hollow cylindrical mounting portion 81 of the contact member 8 to the terminal hole 72 of the battery case 7, the connecting portion 83 is deformed and closely attached to the connection area between the border area 731 of the flange 73 and the inner surface of the peripheral wall 71 of the battery case 7. Preferably, the connection area 731 between the border of the flange 73 and the inner surface of the peripheral wall 71 of the battery case 7 is a slope. Because the connecting portion 83 is closely attached to the slope 731 and extended to the corresponding electric wire 84 in direction far away from the positive terminal of the battery, the connecting portion 83 does not touch the shell (negative terminal) of the battery.

A prototype of battery case has been constructed with the features of FIG. 3. The battery case functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A battery case comprising a terminal hole in a peripheral wall thereof, and a contact member mounted in said terminal hole for the contact of the positive terminal of a battery, said contact member having a cylindrical mounting portion riveted to said terminal hole and a contact portion disposed inside said battery case for the contact of the positive terminal of a battery, and a connecting portion extended from said contact portion and connected to an electric wire, wherein the peripheral wall of said battery case has a flange protruded from an inner surface thereof around said terminal hole and adapted to support said contact portion of said contact member and to keep said connecting portion of said contact member away from the battery to be positioned in the battery case.

2. The battery case as claimed in claim 1, wherein said flange has a peripheral slope sloping toward said electric wire for supporting said connecting portion of said contact member.

3. The battery case as claimed in claim 1, wherein said flange has a circular shape.

4. The battery case as claimed in claim 1, wherein said cylindrical mounting portion of said contact member is a hollow structure.
